(19) United States
(12) Patent Application Publication
(10) Pub. No.: US 2007/0286202 A1
(43) Pub. Date: Dec. 13, 2007

(54) Methods and Systems for Call Admission Control and Providing Quality of Service in Broadband Wireless Access Packet-Based Networks

(75) Inventors: Rene Maria Buniel Dos Remedios, Muntinlupa City (PH); Joel Cruz Delos Angeles, Makati (PH)

Correspondence Address: RENE MARIA B. DOS REMEDIOS, BLDG. 7, LOT 52, FTI COMPLEX, TAGUIG, NCR, 1630, omitted

(73) Assignee: Latitude Broadband Global, Inc.

(21) Appl. No.: 11/423,129

(22) Filed: Jun. 8, 2006

(51) Int. Cl. H04L 12/56

(52) U.S. Cl. 370/395.2

(57) ABSTRACT

Methods and systems for call admission control and providing Quality of Service (QoS) in packet-based networks, with emphasis on those utilizing Wireless Broadband Access, are disclosed. This invention presents a mechanism for implementing call admission in packet-based networks. Quality of Service is also provided by implementing key network functions. Although the access network call admission criteria are illustrated over broadband wireless access, the call admission mechanism principle is access technology-agnostic. Broadband wireless is given emphasis because of its bandwidth-sharing property and relative inefficiency in handling small Voice over IP packets. The invention contemplates on a call admission mechanism for providing reliable packet stream service in IP networks and at the same time passing burstable IP data traffic. Whenever convenient, NGN terms are used in the document—which also stresses the fact that the invention provides a mechanism for implementing NGN end-to-end QoS.

### CROSS-REFERENCE TO RELATED APPLICATIONS

This application acknowledges the benefits of U.S. Pat. No. 6,904,017 B1 entitled “Method and Apparatus to Provide Centralized Call Admission Control and Load Balancing for a Voice-over-IP Network” by Meempat et al. , filed on May 8, 2000 and patented on Jun. 7, 2005, the disclosure of which is incorporated herein by reference in its entirety.

### STATEMENT REGARDING FEDERALLY SPONSORED RESEARCH OR DEVELOPMENT

Not Applicable

### BACKGROUND OF THE INVENTION

Implementing Quality of Service (QoS) in today's packet-based networks is complex because IP, the transport of choice, is designed for best-effort service delivery. End-to-end QoS is especially difficult because of multiple provider domains—each implementing different types of QoS mechanisms, like IntServ and Diffserv, in the transport network. The different QoS mechanisms are all geared towards one goal—which is congestion avoidance. Prioritization, bandwidth management, and PVC provisioning are methods of achieving congestion avoidance. However, the methods themselves do not guarantee QoS. In reality, Quality of Service (QoS) can only be addressed by congestion avoidance. In IP backbone transport networks, the only way to avoid congestion is to be able to monitor link capacities and provide sufficient capacity to carry all the projected link traffic. A simple way of implementing QoS in operator domains is to over-provision bandwidth—which is generally more cost-effective than requiring the backbone routers to have the processing power to be able to handle QoS signaling mechanisms or per-flow traffic classification.

In Next-Generation Networks as cited in the ITU Y.2001 Recommendations, the service stratum includes the Service and Control Functions to deliver session control, registration function, and authentication and authorization at the service level (e.g. voice over IP application). NGN is the natural evolution from the Internet to a new network which will deliver converged services like voice and video. Traditionally, the Internet provides best effort services without support for admission control. If a new call is accepted without limit, undesirable packet loss becomes common to all calls which are in progress over the congested transport link. Thus, admission control becomes necessary for guaranteeing end-to-end QoS for real-time services like VoIP. In the context of NGN terminology, a service like VoIP resides in the service stratum while the network elements are part of the transport stratum. Call Admission functionalities reside in the VoIP service stratum, specifically in the Service and Control Functional (SCF) entity, such as a softswitch. Since an NGN network is QoS-aware SCF in the service stratum communicates with the transport stratum Resource and Call Admission Functional (RACF) entities. Moreover, RACF functionality is spread across the transport stratum—that is, there is RACF for the access network as well as for the core backbone. Implementing call admission in VoIP softswitches without considering the physical transport capacities will not achieve QoS guarantees for the calls.

The Resource and Admission control functions reside in the transport stratum. The Service and Control Function entity in the service stratum connects to the transport RACF to request for allocation of proper transport parameters for the particular service. The SCF entity of a service like VoIP communicates with the transport RACF to request for resources and admission. The RACF then decides and enforces on the transport stratum—core and access—the necessary controls to be able to provide the service. For instance, in a Broadband Wireless Access (BWA) an IP backbone, the RACF entities must be able to provide QoS at the IP core and also at the broadband wireless access network.

Broadband wireless access is of special interest in this paper because of the bandwidth-sharing property of a point-to-multipoint wireless access point or sector. The protocols involved in wireless access are also prone to inefficiencies with the introduction of small packet streams like VoIP. This characteristic of BWA calls for a different mechanism in managing congestion and call admission in the access network. For instance, WiFi technology does not lend itself well to VoIP services. Each wireless technology must be characterized to be able to set the design rules for the data bandwidth that it can pass reliably together with a number of simultaneous VoIP channels. A method of characterizing wireless access technologies to determine the necessary design criteria in providing QoS is presented. Call admission algorithms for backbone IP core networks are already presented in prior arts (Pat. No. 6,904,017). It is necessary to have clear segregation of burstable data traffic and voice traffic, especially in the access network. This paper presents a unified method of implementing call admission and providing QoS for both access and core transports.

Call admission and providing QoS are critical functions and part of the NGN RACF. In order to allow a packet stream session to traverse the network, it must satisfy the RACF criteria for the access and for the core. The invention presented is a superset of the NGN RACF concept. It may be implemented on plain IP packet networks, which are not strictly NGN, yet calls for a QoS mechanism for providing real-time services.

### BRIEF SUMMARY OF THE INVENTION

The only way to guarantee quality of service in IP networks is to avoid congestion. This guiding principle for avoiding congestion to guarantee QoS is followed in the implementing RACF in the core and the access. In core networks, with typical fiber and dedicated microwave links, the utilized capacity per link is the aggregate of all the traffic flowing through it. This is not so for point-to-multipoint BWA. Based on IEEE computations and simulations, as well as on empirical results, the total utilized capacity in a BWA sector is not equal to the aggregate data rates of the traffic flowing through it. This is especially true when small packet traffic like VoIP is passing through the sector. Congestion in broadband wireless access is complicated and requires a fundamental understanding of the access technology and the layer 2 protocols. For instance, the major drawback of WiFi access is the shared Carrier-Sense Multiple Access/Collision Avoidance (CSMA/CA) protocol. Furthermore, current implementations of WiFi use the Distributed Control Function (DCF) flavor of this shared protocol. DCF is based on allocating fixed time slots (or inter-frame spacing) for transmitting frames. This method is very inefficient when transmitting small packets because the time to transmit small packets is essentially the same as the time used to transmit large packets. In effect, less equivalent bandwidth is utilized for the same amount of time making it bandwidth inefficient. Congestion avoidance in the access network is implemented by setting a limit for the burstable data bandwidth combined with monitoring and limiting the number of simultaneous voice calls per wireless sector.

The invention contemplates on a method of implementing key network functions for QoS-awareness of a Broadband Wireless IP network composed of two transport areas—the access and the core. For the access network, the Access Provisioning Server and the Access Controller perform access transport functions, network attachment control functions (NACF), and resource and admission control functions (RACF). Call admission, a part of Service Control Functions (SCF), is performed by the softswitch. The softswitch interfaces to a Call Admission System (CAS) in charge of monitoring the access and core network status to come out with a call admission decision. The CAS consists of the Access Provisioning System, the Network Management System (NMS), and the cooperating database.

For the access network, a hard limit on the number of simultaneous packet streams (e.g. VoIP) per wireless access point is enforced. The wireless sector where a call is originating is determined by including a subscriber index as an identifier of the terminal device in the signaling protocol payload. The Access Controller is also configured to manage a budgeted bandwidth limit for burstable IP data traffic while supporting the VoIP calls. Setting these parameters require precise characterization of the access technology, the details of which is also cited in this paper. The Access Controller is an entity which implements access transport functions, network attachment control, and resource and admission control. In the NGN standard, access functions include bandwidth management, packet filtering, and traffic scheduling and prioritization. Network Attachment Control functions involve management of access network IP addresses and announcement of service contact point (e.g. VoIP softswitch). Most importantly, resource and admission functions (RACF) such as network authentication based on user profiles and control of the access transport functions are implemented in the Access Provisioning System. This method provides an implementation of access RACF in Next-Generation networks.

For the core network, the core resource and admission control (RACF) is implemented through the Network Management System. The actual admission control mechanism for the core is a simplified approach for plain IP networks. This paper illustrates that such a call admission and QoS may be implemented in plain IP networks without inherent support for existing QoS mechanisms such as MPLS, Intserv or Diffserv protocols.

Packet networks with over-provisioned bandwidth, a strong feedback mechanism to monitor the link utilizations, and a way of effecting bandwidth upgrades in advance will always guarantee quality of service even for real-time traffic. The traffic utilizations of all links and the network topology are stored in a database. When call admission is initially implemented, all link utilization fields can be set to an initial value—for instance, these can be equal to the busy hour average link utilization of each link. By updating all the links or hops with the amount of bandwidth of an initiating call, call admission decisions are generated per originating voice session. This method provides an implementation of a core RACF in Next-Generation networks.

The concept of a functional entity—the Access Controller—which separates the access from the core is also explained. The back-end system responsible for controlling the Access Controllers is called the Access Provisioning Server. As we shall see, the Access Controller is a crucial part of the overall approach in guaranteeing QoS for VoIP calls. The Access Controller is the engine for access transport functionalities such as bandwidth management, packet filtering, traffic scheduling and prioritization.

### BRIEF DESCRIPTION OF THE SEVERAL VIEWS OF THE DRAWINGS

A more detailed understanding of the call admission mechanism may be obtained by studying the figures in this paper. The examples serve to illustrate possible scenarios where the invention is most useful. They are not in any way limiting the scope of the invention.

FIG. 1 is a sample network topology which will be used to discuss the details of the invention.

FIG. 2 is a functional diagram showing the relationship among the different network entities. Functions are defined in equivalent NGN terms.

FIG. 3 illustrates the contents of the communication between a service control functional entity (softswitch) and the transport resource and admission control functional entity (Access Provisioning System). It shows the flow and parameters of the admission request and reply.

FIG. 4 shows the bandwidth allocation scheme in the Access Controller.

FIG. 5 is a diagram of how to characterize the access technology to come up with the design criteria for call admission decisions.

FIG. 6 is an illustration of an embodiment of the access network call admission database. The cross-check table shows the parameters which are necessary for the call admission decision in the access network. A simplified structure for the core call admission parameters database is also shown to complete the whole picture.

FIG. 7 shows the flow chart of the steps and decisions involved in the call admission method.

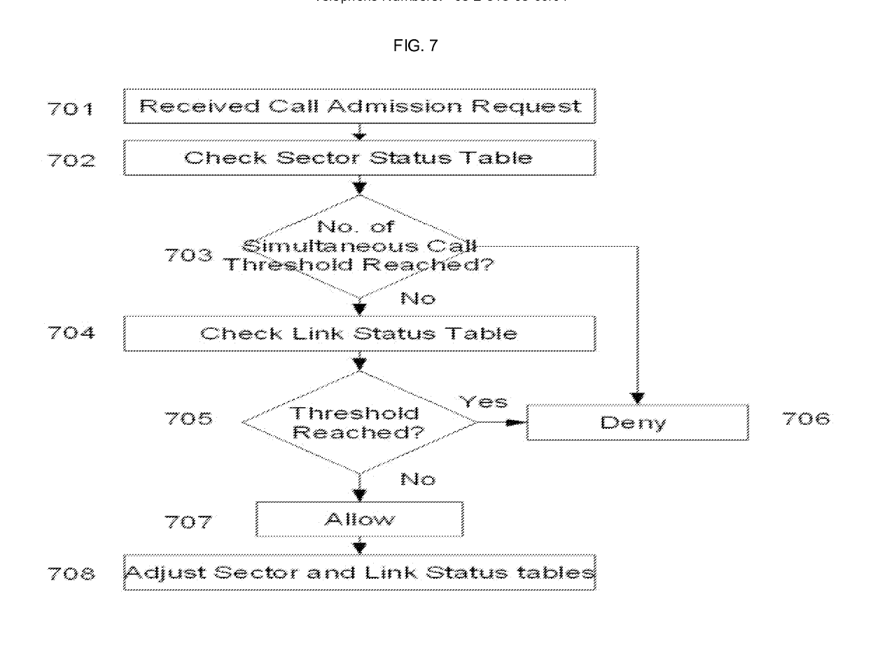

### DETAILED DESCRIPTION OF THE INVENTION

The discussion that follows presents the proposed Call Admission and QoS mechanism in a broadband wireless access IP network. The method combines call admission in the wireless access and in the core network. Whenever convenient, NGN functional terms are used in the discussion.

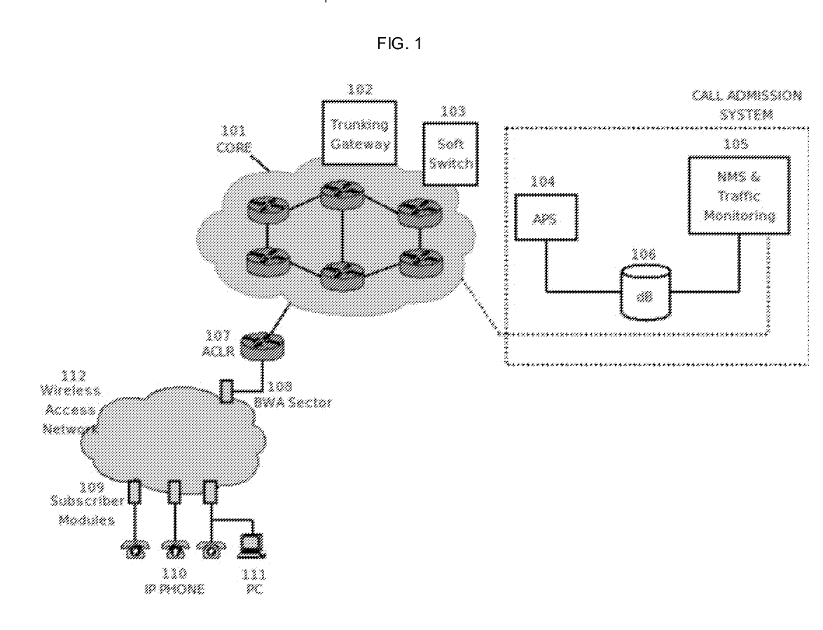

We shall use SIP-based VoIP to illustrate the mechanism of the invention, although it is not limited to this signaling protocol. With respect to FIG. 1, a call is initiated by the calling party to the called party. The called party may either be another IP phone 110 within the BWA network or the trunking gateway 102 to the Public Switched Telephone Network (PSTN). Both the calling party and the called party are registered to the softswitch 103 upon device boot-up. The calling party 110 sends a SIP INVITE message to the softswitch 103 which contains the sender and destination identifiers. The softswitch 103 has a mapping of the source and destination IP address of the calling and called party, respectively. It will be shown later on that these two parameters, the source and destination IP, will be used to implement the call admission at the core network 101.

Another parameter is needed in order to implement call admission at the access network 112. This parameter, the subscriber index 302, will be used to identify on which wireless access point or sector 108 is the subscriber 109 homed to. The index 302 is a piece of information which will be used to identify the sector 108 serving the IP phone 110. In WiFi access networks, the operator can use unique AP ESSIDs as the access index 302. AP ESSIDs clearly identifies where a subscriber terminal is homed to. Since the call setup is done between the IP phone 110 and the softswitch 103, it is recommended that the SIP REGISTER packet be extended to contain the subscriber index 302. Using ESSID in this scenario means that the IP phone terminal 110 should be able to talk to the wireless client 109 to get the AP 108 ESSID so it can send it to the softswitch 103 as the subscriber index 302.

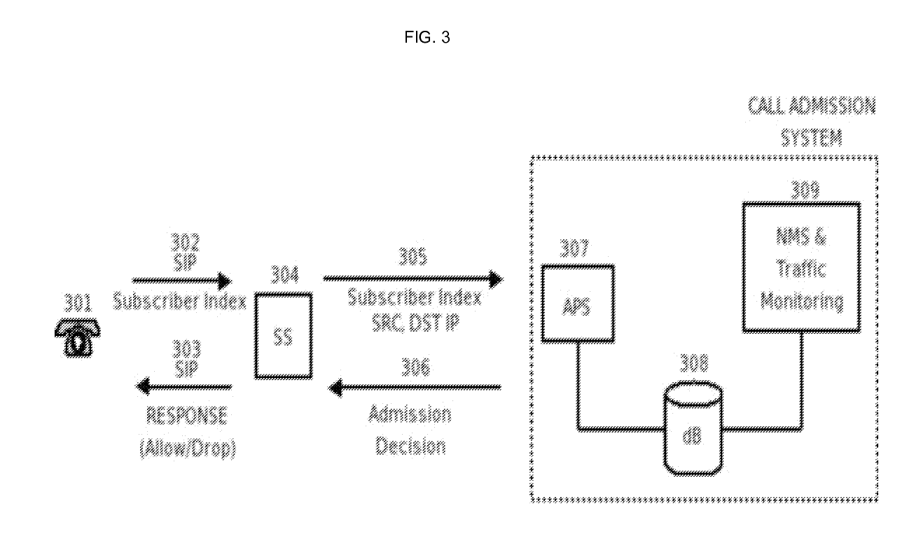

An alternative scenario, as seen in FIG. 3, is to use a terminal identifier such as the IP phone 301 MAC address, a GSM IMEI for a phone with a SIM, or any unique serial number embedded in the hardware terminal identification. For this discussion, the terminal 301 sends its MAC address 302 to the softswitch 304 using the SIP protocol. The softswitch 304 then sends the terminal MAC 305 to the Call Admission System for processing. The Call Admission System has a database 308 of location information for all subscribers in the network. In fixed Broadband Wireless Access 112, this information is updated only during initial subscriber activation or in nomadic instances—when the client chooses to transfer to a new location. Update of the subscriber index 302 in mobile applications requires integration with the handover mechanism and registration at regular intervals. Thus, the terminal MAC address can be used to identify the wireless sector 108. In this paper, each wireless sector 108 is also identified through the unique sector MAC address. This table 601 in the database is essential in determining the sector 108 in the wireless access network 112 where the call request originated. The terminal MAC address is extracted by the softswitch from the SIP message 302. The softswitch 304 then communicates these parameters 305, along with other information such as the voice codec, to the Call Admission System. Call admission decision in the access network 112 will depend on the input terminal 301 MAC address.

Call admission mechanism in the access 112 and the core 101 transports are treated separately in this paper because of the difference in congestion avoidance mechanisms in these two areas. This is especially true in broadband wireless access networks. IEEE papers have shown that existing wireless access technologies, like WiFi, are inefficient in transporting small packet traffic like VoIP. This paper also presents a method of characterizing wireless access technologies in this regard.

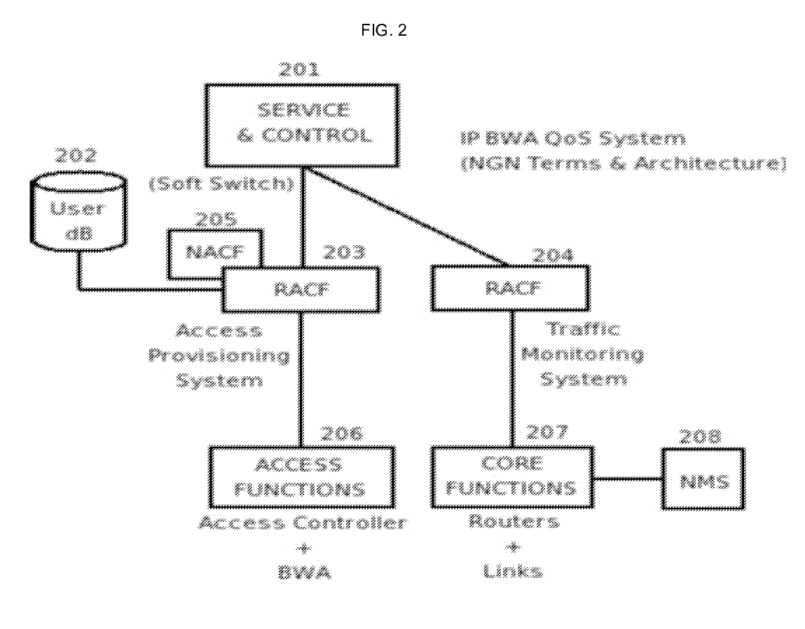

For the sake of discussion, NGN terms are used in the diagram in FIG. 2. Delivering VoIP service on top of a transport network calls for Quality of Service. The service should be able to coordinate with the network transport the necessary Quality of Service guarantees in order to run that particular service. For instance, when setting up a VoIP call, the service functions requests from the transport functions the minimum criteria needed to pass the VoIP traffic. VoIP sessions should be given sufficient bandwidth and minimal delay and jitter for good quality voice call. The Service and Control Functions (SCF) 201 of a softswitch 103, which includes Call Admission, interface to the proper transport entities. Central to the transport functions is the Resource and Admission Control (RACF). The access and core dichotomy is evident in the implementation of the RACF. Different sets of inputs are given to the core RACF 204 and the access RACF 203 by the SCF 201, the source and destination IP addresses for the former and the terminal MAC address for the latter. The response to the softswitch 103 call admission request is a single call admission decision from the RACF entity. This invention presents a method of implementing a resource and admission function through the Call Admission System which consists of the Access Provisioning Server (APS) 104, the Network Management System (NMS) 105, and the cooperating database 106. Network Attachment and Control Functions (NACF) 205 can also be found in the Access Provisioning Server 104.

Network Attachment Control functions (NACF) 205 involve management of access network IP addresses and announcement of service contact point (e.g. VoIP softswitch). In the network diagram, every wireless sector cluster or base station has one Access Controller 107. The Access Controller 107 can have just a single public IP address facing the core network and perform Network Address Port Translation (NAPT) for the access private IP segment. Management of the private IP addresses of the subscriber access terminals, like the PC 111 and the IP phone 110, is done via Dynamic Host Configuration Protocol (DHCP). Public addresses are also supported. Announcement of service contact point, like the operator softswitch 103 IP address, can also be done using DHCP version 6 or using the tftp-server field of DHCP version 4. In the latter option, a tftp server contains the softswitch 103 IP address information by hosting a configuration file which is fetched by the IP phone terminal 110.

Resource and admission functions (RACF) include network authentication based on user profiles and control of the access transport functions. A subscriber 110 is authorized to use the network by authenticating against the Access Provisioning Server (APS) 104. The APS 104 is the back-end server in charge of management of the Access Controllers 107 in the network. The RACF checks against the user database 202 the profile of a subscriber and determines whether to allow it to use the network or not. The APS 104 then gives specific instructions to the corresponding Access Controller 107 to implement access transport functions. In the NGN standard, access functions include bandwidth management, packet filtering, and traffic scheduling and prioritization. The entity responsible for these functions is the Access Controller 107. Although each broadband wireless access sector 108 may also implement some of these access transport functions, the Access Controller 107 is in a much better position to manage the bandwidth being fed to the whole base station among the subscribers in all of the wireless sectors. In contrast to a single wireless sector managing only its own available bandwidth, the Access controller 107 knows the total base station backhaul available bandwidth, the number of wireless sectors in the base station, and the total number of subscribers per sector. These parameters are vital to an effective bandwidth management of the entire base station.

In general, an Access Controller 107 is necessary in access to transport and transport to transport interface points where there is a capacity mismatch. The Access Controller 107 performs buffer management and queuing. QoS is guaranteed by managing and sharing the bandwidth of the transport component of a lower capacity. The Access Controller 107 can also be used as lawful intercept points which is a key management function in an NGN.

The Access Controller 107 is a functional entity in charge of the access transport functions. It is capable of allocating committed information rate (CIR) to each subscriber terminal as well as the maximum information rate (MIR). In actual implementation every personal computer terminal 111 is given CIR/MIR based on the user profile stored in the APS 104 database. The network authentication communication may be implemented in several ways. One is through the standard IEEE 802.1x between the PC 111 and the wireless sector 108 coupled with RADIUS or DIAMETER between the wireless sector and the back-end server. The disadvantage of 802.1x is that a supplicant software must be installed on the PC 111. Moreover, 802.1x do not have bandwidth management functionalities. Implementing it this way calls for a separate interface between the back-end server and the Access Controller 107. A better alternative is for the Access Controller 107 to redirect all http traffic to a central portal in the Access Provisioning Server 104. The user will then login to this portal and the APS 104 will authenticate accordingly. The APS 104 then instructs the Access Controller 107 whether to deny or allow the terminal and what CIR/MIR package should be given. The second option has the advantage of browserbased interface and a single interface protocol between the APS 104 and the Access Controller 107. Utilizing the APS 104 and the Access Controller 107 also makes the network design access-technology agnostic. The Access Provisioning System 104 described in this paper would support any Ethernet-based wireless technology such as WiFi or Wimax.

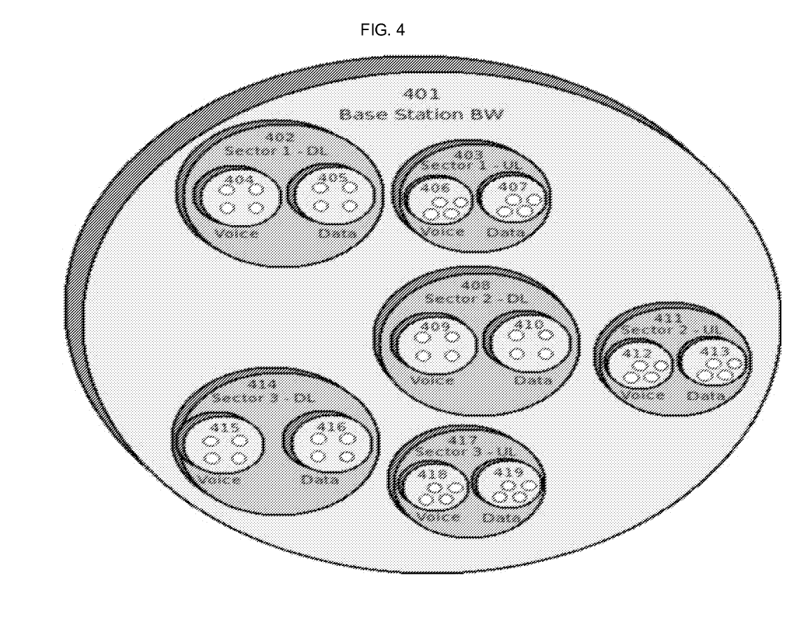

The capabilities of the Access Controller 107 lead us to the discussion of how to treat real-time packet streams and burstable Internet traffic separately. The Access controller 107 is capable of sharing a bandwidth pipe 404 among multiple terminals 401. Moreover, it is capable of guaranteeing CIR per terminal. It is recommended that the bandwidth pipe for all burstable Internet traffic 405 separated from all real-time packet stream traffic 404 type. Delivering VoIP means that two pipes will be configured on all Access Controllers 107—one for burstable data traffic 405 and another for VoIP 404. Other real-time services may also be given a separate pipe. The APS 104 configures this setup on all Access Controllers 107. As previously cited, the Access Controller 107 is capable of sharing a single base station backhaul bandwidth 401 among the wireless sectors and the subscriber terminals. It is therefore implied in the above discussion that the data 405 and voice 404 pipe separation is a characteristic of a single sector pipe 402. Thus the backhaul bandwidth 401 is divided among sectors, the sector between Internet data 405 and voice 404, and these pipes among the PCs and IP phones, respectively. A sector 108 may also have separate bandwidth for uplink and downlink as you can see in FIG. 4.

Voice traffic is prioritized over burstable Internet data. Aside from giving the subscriber with burstable data package, say a 16 kbps CIR and 384 kbps MIR, it is also given a lower priority compared to a voice terminal. For a voice terminal using G.729, 40 ms sampling codec, the Access Controller gives it a 16 kbps CIR and 16 kbps MIR. It is also given a higher priority compared to the data only subscriber. Bandwidth management and prioritization is done per terminal—with the MAC address and IP address as the identifiers. The terminal bandwidth pipes are connected to their corresponding root pipes—the voice and data bandwidth pipes. Note that being able to configure priority in the Access Controller 107 gives the operator of the network control of the service being offered by third-party VoIP providers. Since it has been shown that too much small packet traffic degrades the performance of BWA, the network operator may choose to combine the third-party VoIP traffic with the lower-priority burstable data traffic.

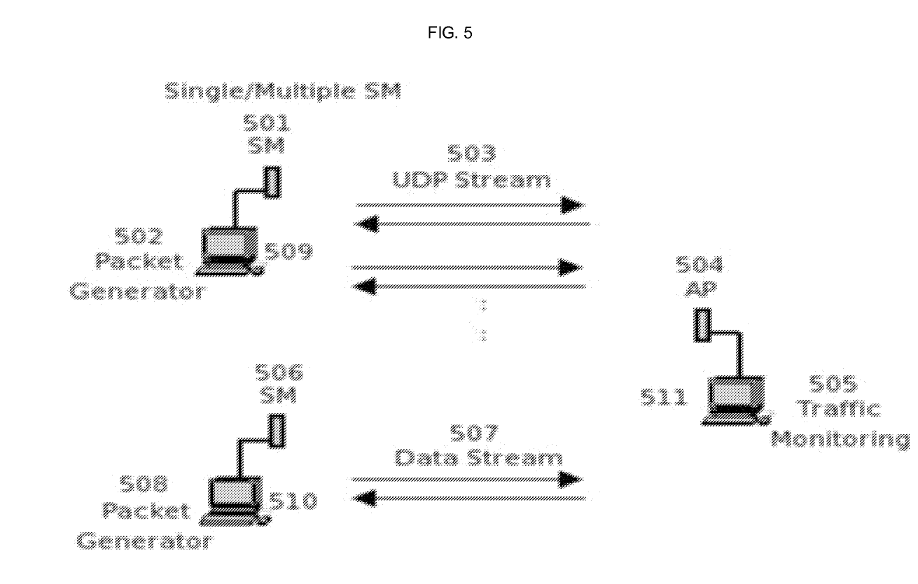

The next discussion shows a method of characterizing a wireless access technology and come up with the design parameters, such as the size of the burstable data pipe and how many simultaneous calls should be permitted per sector 504, see FIG. 5. The result of the empirical tests of wireless access technologies is also fundamental to the understanding of the difference between the call admission mechanism in the access and that of the core 101.

First, the maximum bandwidth that a radio can achieve is determined. This is easily determined using file transfer traffic measurement across the wireless link. For instance, a radio technology under consideration reaches 5.5 Mbps on the downlink and 1.5 Mbps on the uplink. Second, the radio's voice capacity is obtained by using a program 502 that simulates voice calls. The program generates packet streams of the same data rate, packet size, and sending interval as a VoIP packet stream using a given codec, say G.729, 40 ms. The number of packet streams 503 running through the link is increased until packet losses are observed. Packet losses become evident when the total traffic being received by one end of the link is less than the total traffic sent at the other end. Consequently, the maximum number of voice calls that can be handled by wireless link is equal to the maximum number of running packet streams 503 before packet losses are observed. Finally, mixed voice and Internet data capacity of wireless sector is measured by using two client PCs for simultaneous voice 502 and data simulation 508, respectively. The initial number of simultaneous calls is set, say at 5, and the available data bandwidth for file transfer is measured. The setting for the number of simultaneous calls is increased. The result of file transfer test for each setting is measured. The final output is a budgeted burstable data bandwidth and a recommended limit for the number of simultaneous calls. The recommended codec is determined by simulating a range of codecs and determining which codec yields the highest number of simultaneous calls.

The empirical results show some unique characteristics of the wireless access technology which lead us to sound network design guidelines. The burstable Internet data pipe on the Access Controller 107 should be budgeted. In the example described, the budget for the burstable Internet data traffic is 5 Mbps for the downlink and 1 Mbps for the uplink. This leaves us with 0.5 Mbps for uplink and downlink voice. Simple mathematics tells us that we should be able to support up to 31×G.729, 40 ms streams each using up 16 kbps per direction. However, the 80% efficiency of a typical BWA technology only affords us 25 maximum simultaneous calls per sector. The characterization also shows that there is a knee point where the efficiency drops to an intolerable level. When the number of simultaneous VoIP calls goes beyond 40, the efficiency breaks down. In fact the maximum limit for this access technology is only around 75 simultaneous calls. Those skilled in the art will be contented with the figure of 25 because at 100 mErlangs, this already effectively translates to 250 VoIP subscribers per sector. Note that another output of the exercise is a recommended codec for a typical BWA network—for example, G.729, 40 ms sampling for this case.

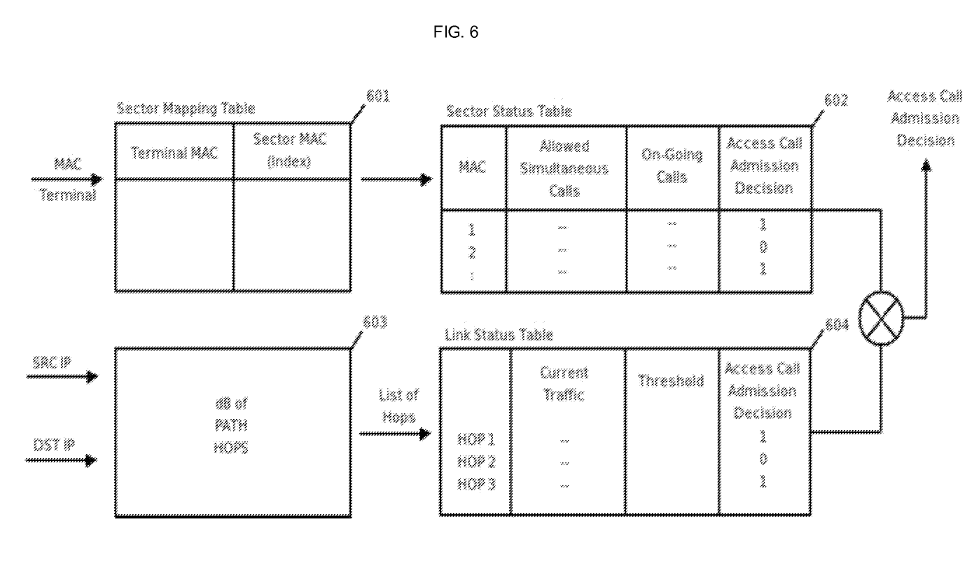

Call admission mechanism in the access 112 and the core 101 are treated separately because point-to-multipoint wireless access behaves differently from the core transport technologies. For the access call admission, the softswitch 304 passes the terminal MAC address 305 to the Call Admission System for sector indexing. The server then determines how many calls are ongoing per sector 108 and determines whether allowing the requesting call will violate the simultaneous voice call limit per sector. The database which maps the terminal MAC address, the sector MAC address, and the corresponding number of ongoing calls, is shown in FIG. 6. In order to allow the call, the decision to allow it should satisfy the access call admission criteria and the core call admission criteria.

The core transport admission criteria for determining whether to allow the call is defined in prior arts. The source and destination IP addresses translate to an array of transport links 603 where the call may pass. In redundant IP networks, the call may traverse a number of possible paths, each consisting of its own set of hops. The array then contains the union of the possible network hops. All combinations of voice call source and destination IP segments are stored in the database. Per combination item entry, the database 603 stores the possible hops which a corresponding call may traverse. This may be computed offline using a path traversal algorithm. A typical approach would be to store in a database of the links and the nodes. VoIP path topologies may be calculated by determining on which nodes the VoIP stream to and from the source and destination segments will meet. It is recommended that all the possible link hops for each source-destination IP segment combination be computed a priori in order to decrease the call setup time which includes the call admission criteria checking step.

A failed link or an inferior-metric link from the possible hop list may also be incorporated in the generation of the hop array. This requires coordination with the NMS 105 which performs link outage and traffic monitoring. A simple rule could be if any one link—the weakest link—goes beyond a threshold, the call is denied.

The database table 604 contains the estimated utilization of all the hops. Initially, this can be set to the busy-hour utilization of the previous day. These values are updated for every call establishment or tear-down. Each link estimate is increased or decreased by the value of the VoIP bandwidth—which is dependent on the codec for the call. The links are then checked against their corresponding thresholds. An alarm threshold is also set for each link. When this value is reached for any of the links, an alarm is triggered not to allow the current call whose entry into the network increased the estimated utilization value past the threshold. Another rule which can be implemented is a strict requirement to use only the recommended codec for the access technology. All call admission decisions—core and access—are combined for a single call admission decision which will be sent by the Call Admission System (RACF) to the softswitch (SCF) 201.

It is worth emphasizing that proposed Call Admission mechanism can be used in plain IP networks as well as in network utilizing MPLS for network QoS-awareness. The call admission mechanism applies to MPLS backbone cores and even complements such design where explicit paths are readily determined. A valuable insight is that the call admission mechanism presented enables Quality of Service even in plain IP core networks such as those utilizing BGP and OSPF. In such networks, providing QoS in the backbone by congestion avoidance is achieved through simple bandwidth over-provisioning. This over-provisioning bandwidth at the core is more cost-effective than fast-processing routers which try to achieve the same end—congestion avoidance. The network diagram presented in FIG. 1 does not show MPLS routers in the core 101. Operators with MPLS cores may also be tempted to implement per call bandwidth reservation which is possible given the label or tag approach of MPLS. Those skilled in the art would easily notice that such approach has serious scaling concerns. The fallback is to aggregate the voice calls on MPLS paths which will act as trunks. Plain IP paths serve also as packet-based trunks, whose utilization also needs close monitoring. In summary, the call admission and QoS provisioning approach presented in this paper provides strong traffic monitoring feedback and strengthens plain IP backbone core networks without the need for MPLS or Diffserv routers.

This call admission mechanism achieves two very important things for the network operator:
1. The Quality of Service (QoS) is always guaranteed per call across the entire Broadband Wireless Access network.
2. The frequency of alarms for each link forces the network operator to always over-provision bandwidth. Over-provisioning of bandwidth is a simple way of guaranteeing QoS at the backbone and is more cost-effective than implementing QoS at the router points. The call admission mechanism provides additional feedback to the Network Monitoring System (NMS) 105 in order to maintain the links below the thresholds.

Note that this invention does not require a Next-Generation Network for actual implementation. The mechanism presented in this paper enables QoS even in packet-based networks and can be used as the mechanism of choice for implementing the NGN requirement for end-to-end QoS.

The invetion has been described in terms of illustrations to explain its principles and concepts. It is intended that the invention be construed as including any modification on these concepts insofar as they come within the scope of the appended claims.

Having described the concepts in terms of illustrations, the invention we now claim to be are as follows:

1. A method of implementing call admission and providing QoS in Broadband Wireless IP networks composed of two transport areas: the access and the core, the method comprising of:
(a) receiving a request for establishment of a packet stream service, such as a VoIP call, in a softswitch, the request consisting of the originating terminal MAC address identifier and the codec to be used
(b) passing these parameters together with the source and the destination IP address of the calling and the called party, respectively, to the Call Admission System
(c) generating a response by the Call Admission System whether to admit the new call
(d) sending an allow or a deny message to the calling party terminal device using standard signaling protocols (e.g. SIP)

2. The method as set forth in claim 1 wherein the calling party terminal sends the MAC address identifier as part of the signaling payload (e.g. SIP packets).

3. The method as set forth in claim 1 wherein a communication interface is established between the softswitch and the Call Admission System to generate a call admission decision, consisting of:
(a) establishing a service control to resource and admission control (SCF to RACF) communication interface between the softswitch and the Call Admission System
(b) generating a call admission decision based against the criteria for the access and the core

4. A system (CAS) of claim 3 for generating call admission decisions, implementing resource and admission control functions (RACF), and interfacing to the softswitch (SCF), the system comprising:
(a) the Access Provisioning Server
(b) the Network Management System
(c) the cooperating database

5. A system in claim 4 called the Access Provisioning Server which implements:
(a) control of the Access Controller to perform network attachment control functions (NACF) such as management of access network IP addresses and announcement of service contact point (e.g. softswitch IP address)
(b) control of the Access Controller access transport functions (RACF)
(c) enforcing a hard limit on the number of simultaneous packet streams on every BWA sector

6. A system in claim 4 called the Network Management System (NMS) which implements:
(a) monitoring of all estimated utilizations of all links based on busy-hour average traffic together with real-time call setup and teardown bandwidth change
(b) enforcing a limit on the maximum traffic that will be allowed on the links based on set threshold

7. A system in claim 5 called the Access Controller which implements access transport functions such as bandwidth management, packet filtering, and traffic scheduling and prioritization.

8. A system in claim 5 called the Access Controller network which separates the bandwidth pipe for burstable Internet data and voice traffic and to implement access transport function parameters as instructed by the Access Provisioning Server, the parameters comprising of:
(a) the committed information rate (CIR) and maximum information rate (MIR) for each subscriber terminal, like the PC or IP phone
(b) the subscriber terminal traffic marked in terms of source IP, destination IP, source port, destination port
(c) the prioritization of voice traffic over burstable data traffic
(d) managing the bandwidth of the backhaul fed to the base station and dividing it on a per sector basis, between uplink and downlink traffic, between voice and burstable data traffic, and among the subscriber terminals

9. The method as set forth in claim 3 wherein the Call Admission System generates a call admission decision to determine whether the access and core criteria are met, comprising of:
(a) determining the IP phone terminal to wireless sector mapping in a database containing processed queries of the wireless sector equipment bridging tables
(b) dynamically updating the database with the number of concurrent calls per sector
(c) computing of the admission decision from the status of the access and the core transport and applying it in response to the call admission request
(d) fulfilling the access admission criteria which is based on the characterization of the wireless technology
(e) fulfilling the core admission criteria

10. The method as set forth in claim 9 wherein characterization of the wireless technology arrives at the recommended codec, the budgeted Internet burstable data (non-real time) bandwidth allowance, and the number of simultaneous packet stream channels that will be allowed per wireless access point or sector, comprising of:
(a) simulating the multiple packet streams running over a wireless sector or access point;
(b) formation of traffic stream packets and bit rate as derived from the codec being used (e.g. G.729, G.711 for VoIP);
(c) running multiple packet streams together with a controlled IP data traffic (e.g. ftp) over a single wireless access point or sectors
(d) determination of the recommended codec for the access technology based, the budgeted IP non-real-time, burstable data traffic, and the allocated packet stream channels per wireless sector
